(19) United States
(12) Patent Application Publication
(10) Pub. No.: US 2011/0093904 A1
(43) Pub. Date: Apr. 21, 2011

(54) Motion picture providing apparatus, motion picture providing method, and program

(75) Inventors: Tetsuo Maruyama, Tokyo (JP); Tetsu Sumita, Tokyo (JP); Fumiko Sekijima, Tokyo (JP)

(73) Assignees: Sony Corporation, Tokyo (JP); Plat-Ease Corporation, Tokyo (JP)

(21) Appl. No.: 12/924,415

(22) Filed: Sep. 27, 2010

(30) Foreign Application Priority Data
Oct. 15, 2009 (JP) P2009-238458

(51) Int. Cl. H04N 7/173

(52) U.S. Cl. 725/87

(57) ABSTRACT

There is provided a motion picture providing apparatus including a keyword management section which manages, in order to search a motion picture related to content, a keyword registered with respect to the content, a viewing state acquisition section which acquires a viewing state of content from an outside TV, a keyword specification section which specifies a keyword registered with respect to the content which is being viewed by using the acquired viewing state, a motion picture selection section which selects one or more motion pictures that satisfy a predetermined reference from among one or more motion pictures searched by one or more outside motion picture sharing devices by using the specified keyword, and a motion picture providing section which acquires, from the motion picture sharing devices, a motion picture designated by a viewer from among the selected motion pictures, and provides the acquired motion picture to the TV.

### BACKGROUND OF THE INVENTION

1. Field of the Invention

The present invention relates to a motion picture providing apparatus, a motion picture providing method, and a program.

2. Description of the Related Art

In recent years there has been practically used a system which, in viewing content using a display device such as a television receiver (hereinafter, also referred to as TV), searches a motion picture related to the content from a motion picture-sharing site and provides the searched motion picture to the TV. In the system, the motion picture related to the content is searched from a large number of motion pictures and is provided, by using information included in EPG (electronic program guide) information of the content, for example.

### SUMMARY OF THE INVENTION

However, there were cases where it was difficult for the system in the past to search and provide an appropriate motion picture that a content viewer desires. One of the reasons therefor may be considered to be that the original purpose of the information included in the EPG information is to guide the content, and is not to search a motion picture related to the content.

For example, in the case of using the EPG information, there is an issue of which information is to be used as a search keyword among the pieces of information included in the EPG information. Further, there is also an issue that it is difficult to use the information which is not included in the EPG information as the search keyword in the first place.

In light of the foregoing, it is desirable to provide a novel and improved motion picture providing apparatus, motion picture providing method, and program which are capable of appropriately searching and providing a motion picture desired by a viewer of content.

According to an embodiment of the present invention, there is provided a motion picture providing apparatus which includes a keyword management section which manages, in order to search a motion picture related to content, a keyword registered with respect to the content, a viewing state acquisition section which acquires a viewing state of content from an outside display device, a keyword specification section which specifies a keyword registered with respect to the content which is being viewed by using the acquired viewing state, a motion picture selection section which selects one or more motion pictures that satisfy a predetermined reference from among one or more motion pictures searched by one or more outside motion picture sharing devices by using the specified keyword, and a motion picture providing section which acquires, from the motion picture sharing devices, a motion picture designated by a viewer from among the selected motion pictures, and provides the acquired motion picture to the display device.

According to the above configuration, the motion picture providing apparatus acquires a viewing state of content from a display device, and specifies a keyword that is registered in order to search a motion picture related to content with respect to the content which is being viewed. Then, the motion picture providing apparatus selects one or more motion pictures that satisfy a predetermined reference from among one or more motion pictures searched by one or more outside motion picture sharing devices by using the keyword, acquires, from the motion picture sharing devices, a motion picture designated by a viewer from among the selected motion pictures, and provides the acquired motion picture to the display device. Thus, by registering the keyword in a manner that the searching of the motion picture related to the content is an original purpose, it is possible to appropriately search and provide the motion picture desired by the viewer of the content.

Further, the keyword management section may manage a keyword which is registered before provision of content and a keyword which is registered in association with provision of content on a real-time basis.

Further, the motion picture selection section may use a predetermined index included in motion picture information of a motion picture which is managed by each of the motion picture sharing devices, and may select a motion picture having a value of the index which satisfies a predetermined reference. Here, the predetermined index may be selected from at least one of a number of reproduction times, a degree of association, a degree of popularity, and a degree of evaluation of the motion picture. Further, the motion picture selection section may evaluate a value of the predetermined index based on characteristics of two or more motion picture sharing devices, and may select a motion picture having the evaluated index value which satisfies a predetermined reference.

Further, the motion picture selection section may use a different predetermined index depending on viewing duration of content, and may select a motion picture having a value of the index which satisfies a predetermined reference. Further, the motion picture selection section may use a predetermined index value depending on viewing duration of content, and may select a motion picture having the index value which satisfies a predetermined reference.

Further, the motion picture selection section may use a view log of a motion picture of the viewer, and may preferentially select a motion picture which is managed by a specific motion picture sharing device. Further, the motion picture selection section may use a predetermined index depending on a view log of a motion picture of the viewer, and may preferentially select a motion picture having a value of the index which satisfies a predetermined reference. Further, the motion picture selection section may use a view log of a motion picture of the viewer, and may preferentially select a motion picture which is viewed by the viewer with respect to content related to the content which is being viewed.

Further, the motion picture selection section may use a view log of a motion picture of another viewer, and may preferentially select a motion picture which is viewed by the other viewer with respect to the content which is being viewed or content related to the content which is being viewed.

Further, the motion picture providing apparatus may further include a recommended motion picture management section which manages one or more recommended motion pictures capable of attracting a high degree of attention from a general viewer, and the motion picture selection section may select a motion picture which the motion picture providing apparatus manages and may also select a recommended motion picture which corresponds to a keyword from among recommended motion pictures managed by the recommended motion picture management section.

Further, the motion picture selection section may select motion pictures, the number of which depends on display performance of the display device.

Further, the motion picture providing section may further provide information related to content associated with the content which is being viewed. Here, the content associated with the content which is being viewed may be content currently being provided.

Further, according to another embodiment of the present invention, there is provided a motion picture providing method which includes the steps executed by a computer of managing, in order to search a motion picture related to content, a keyword registered with respect to the content, acquiring a viewing state of content from an outside display device, specifying a keyword registered with respect to the content which is being viewed by using the acquired viewing state, selecting one or more motion pictures that satisfy a predetermined reference from among one or more motion pictures searched by one or more outside motion picture sharing devices by using the specified keyword, and acquiring, from the motion picture sharing devices, a motion picture designated by a viewer from among the selected motion pictures, and providing the acquired motion picture to the display device.

Still further, according to another embodiment of the present invention, there is provided a program for causing a computer to execute a motion picture providing method. Here, the program may be provided by using a computer-readable recording medium and may be provided via communication means.

According to the embodiments of the present invention described above, there can be provided the motion picture providing apparatus, the motion picture providing method, and the program which are capable of appropriately searching and providing a motion picture desired by a viewer of content.

### BRIEF DESCRIPTION OF THE DRAWINGS

FIG. 1 is a diagram showing a motion picture providing system including a motion picture providing server according to an embodiment of the present invention;

FIG. 2 is a block diagram showing a main functional configuration of a motion picture providing server;

FIG. 3 is a diagram showing a registration method of a keyword of content;

FIG. 4 is a block diagram showing a main functional configuration of a television receiver;

FIG. 5 is a sequence diagram showing a basic procedure of a motion picture providing method;

FIG. 6 is a diagram showing a method of selecting a motion picture using an index value of a motion picture;

FIG. 7A is a diagram showing a method of selecting a motion picture using viewing duration of content;

FIG. 7B is a diagram showing a method of selecting a motion picture using viewing duration of content;

FIG. 8A is a diagram showing a method of selecting a motion picture using a view log of a viewer;

FIG. 8B is a diagram showing a method of selecting a motion picture using a view log of the viewer;

FIG. 8C is a diagram showing a method of selecting a motion picture using a view log of the viewer;

FIG. 9 is a diagram showing a method of selecting a motion picture using a view log of another viewer;

FIG. 10A is a diagram showing a method of displaying a motion picture;

FIG. 10B is a diagram showing a method of displaying a motion picture;

FIG. 10C is a diagram showing a method of displaying a motion picture;

FIG. 10D is a diagram showing a method of displaying a motion picture; and

FIG. 11 is a block diagram showing a hardware configuration of a motion picture providing server.

### DETAILED DESCRIPTION OF THE EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

### 1. CONFIGURATION OF MOTION PICTURE PROVIDING SYSTEM

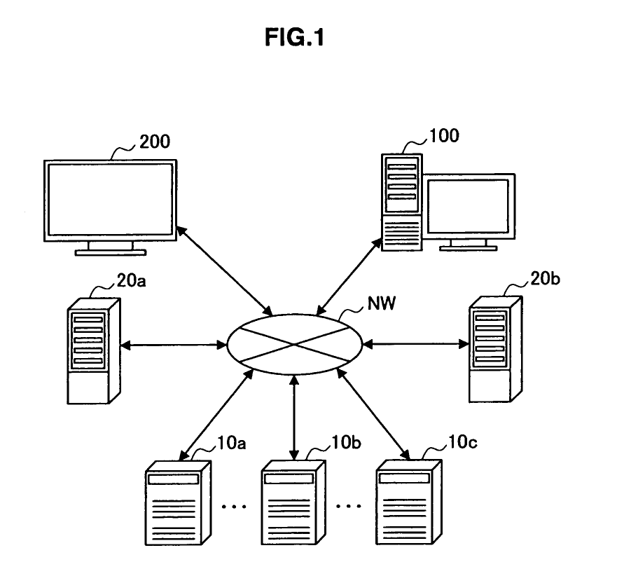

FIG. 1 is a diagram showing a motion picture providing system including a motion picture providing server 100 according to an embodiment of the present invention. As shown in FIG. 1, the motion picture providing system includes the motion picture providing server 100, a television receiver 200 (hereinafter, may be referred to as TV 200), one or more motion picture sharing servers 10a to 10c, and one or more service servers 20a and 20b. The motion picture providing server 100 is connected to the TV 200, the motion picture sharing servers 10, and the service servers 20 via a network NW.

The motion picture providing server 100 provides a motion picture related to content which is being viewed on the TV 200 to the TV 200. The motion picture providing server 100 acquires a motion picture related to the content from the motion picture sharing server 10, and acquires information and the like related to the content from the service server 20. The TV 200 displays the content and the motion picture or the like related to the content. Note that the TV 200 is an example of a display device including a personal computer, a PDA, a mobile phone, or the like.

The motion picture sharing server 10 realizes the sharing of a motion picture between user terminals (not shown), which is uploaded from the user terminal. The motion picture sharing server 10 has a motion picture search function, and, in accordance with an instruction of a keyword, searches a motion picture corresponding to the keyword. Further, the motion picture sharing server 10 has a motion picture management function, and manages the motion picture based on the user's viewing state of the motion picture. The service server 20 manages content-related information and the like, and, in response to an acquisition request, provides information corresponding to the acquisition request.

In viewing content, a viewer can view a motion picture related to the content by acquiring the motion picture related to the content from the motion picture providing server 100. Specifically, the motion picture providing server 100 acquires a viewing state of the content from the TV 200, and specifies a keyword registered with respect to the content which is being viewed by using the acquired viewing state. Next, the motion picture providing server 100 uses the specified keyword and selects a motion picture which satisfies a predetermined reference from among motion pictures searched by one or more motion picture sharing servers 10. After that, the motion picture providing server 100 acquires a motion picture designated by the viewer from among the selected motion pictures, and provides the motion picture to the TV 200.

Here, the motion picture related to the content which is being viewed is searched by using a keyword which is being registered for the purpose of searching the motion picture related to the content with respect to the content which is being viewed. Accordingly, when the keyword is registered in a manner that the searching of the motion picture related to the content is an original purpose, it becomes possible to appropriately search and provide the motion picture desired by the viewer of the content.

### 2. CONFIGURATION OF MOTION PICTURE PROVIDING SERVER 100

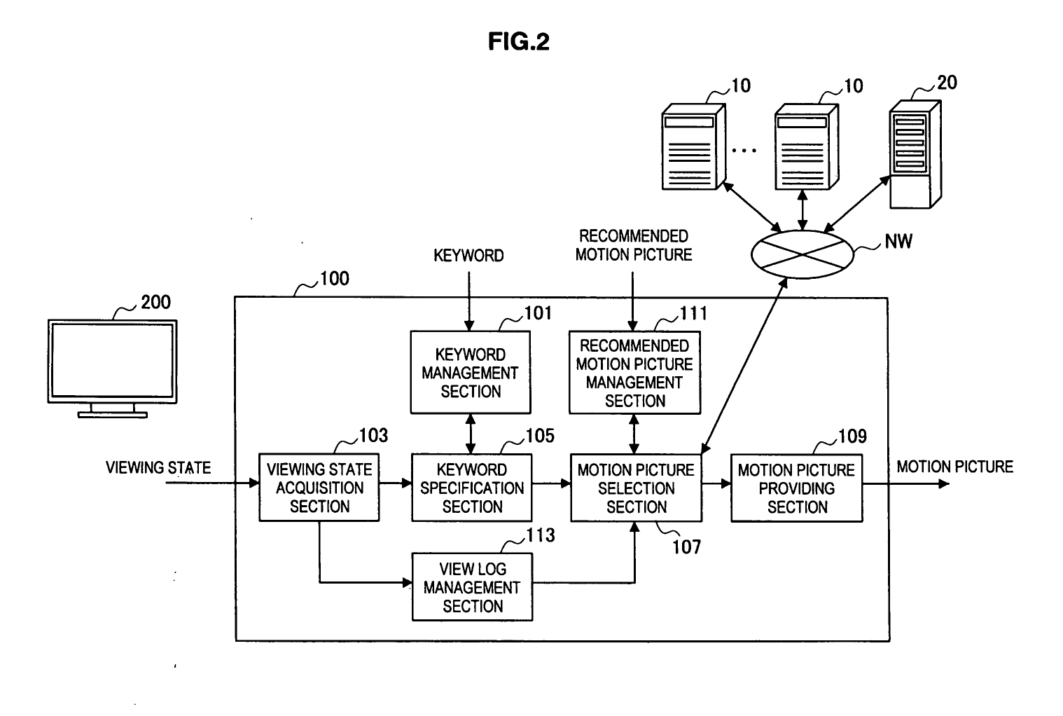

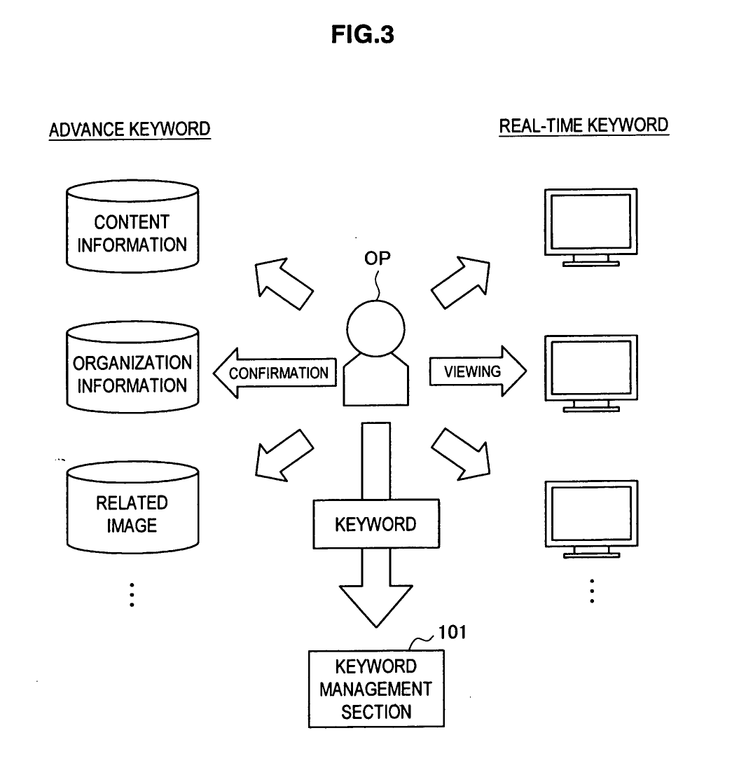

FIG. 2 is a block diagram showing a main functional configuration of the motion picture providing server 100. FIG. 3 is a diagram showing a registration method of a keyword of content. As shown in FIG. 2, the motion picture providing server 100 includes a keyword management section 101, a viewing state acquisition section 103, a keyword specification section 105, a motion picture selection section 107, a motion picture providing section 109, a recommended motion picture management section 111, and a view log management section 113.

The keyword management section 101 manages one or more keywords registered with respect to content by associating the keyword with an ID or the like of the content. Note that the keyword management section 101 may also manage the keyword registered with respect to a motion picture by associating the keyword with an ID or the like of the motion picture.

FIG. 3 shows a registration method of a keyword of content. As shown in FIG. 3, the keyword of content is registered by an administrator OP of the motion picture providing server 100. The keyword of the content is registered for the purpose of searching a motion picture related to the content.

The keyword of the content is registered as an advance keyword and/or a real-time keyword. The advance keyword is registered before the content is provided, by using content information, content organization information, a related image related to the content, and the like. On the other hand, the real-time keyword is registered in association with the provision of the content by monitoring the change that occurs in the content itself on a real-time basis.

The real-time keyword is registered for enabling the search of more appropriate motion picture by a keyword which is registered in association with the provision of the content rather than a keyword registered before the provision of the content, such as a live broadcast of a sports program and the like. Note that the real-time keyword may be registered instead of the advance keyword, or may be registered separately from the advance keyword.

Note that, in the case where a keyword of a motion picture is registered for the purpose of searching another motion picture and content related to the motion picture, the keyword of the motion picture is registered by being associated with an ID or the like of the motion picture using motion picture information (uploading source, details of the motion picture, outline description, related image, and the like).

The viewing state acquisition section 103 acquires viewing states of content and a motion picture from the TV 200. The viewing state includes user information of the viewer and information capable of specifying the content or the motion picture which is being viewed on the TV 200.

The user information of the viewer includes information capable of specifying a viewer on the network NW, such as an ID of the viewer, and may include a profile of the viewer (age, sex, resident area, and the like). Note that an ID of the TV 200 (MAC address and the like) may be acquired instead of the user information of the viewer. The information capable of specifying content or a motion picture is an ID or the like of the content or the motion picture. The information capable of specifying the content may be the ID of the channel which provides the content.

The keyword specification section 105 specifies a keyword registered with respect to content or a motion picture which is being viewed by using the viewing state of the content or the motion picture. The keyword is specified from a content ID or a motion picture ID. In the case of content, the keyword may be specified from a channel ID and time information.

The motion picture selection section 107, as will hereinafter be described in detail, selects a motion picture which satisfies a predetermined reference from among motion pictures searched by one or more motion picture sharing servers 10 by using a keyword. The motion picture selection section 107 transmits the keyword to one or more motion picture sharing servers 10, and receives pieces of motion picture information of one or more motion pictures searched by using the keyword from the motion picture sharing servers 10.

Here, the motion picture information includes an ID of the motion picture, details of the motion picture (uploading source, details of the motion picture, outline description, related image, and the like), an index value (number of reproduction times, degree of association, degree of popularity, degree of evaluation, or the like of the motion picture), and the like. The motion picture information is managed by respective motion picture sharing servers 10.

The number of reproduction times represents a total number of times the motion picture is reproduced by an unspecified number of users who use the motion picture sharing servers 10. The degree of association represents the intensity of the relation between motion pictures, and is determined based on details of the motion pictures. The degree of popularity represents a relative popularity of the motion picture within a specific service territory, and, in the case where the degree of popularity is “90”, it means that there are ten more motion pictures whose number of reproduction times is larger than the number of reproduction times of the motion picture. The degree of evaluation represents the evaluation results of the motion picture by an unspecified number of users, and the motion picture is quantitatively evaluated using a predetermined evaluation index or the like.

Further, the motion picture selection section 107, as will be described later, may select a motion picture corresponding to the keyword from among motion pictures managed by the recommended motion picture management section 111, as a motion picture capable of attracting a high degree of attention from a general viewer. In addition, the motion picture selection section 107 may also select information corresponding to the keyword from among information of content, advertisement information related to the content, information of another content related to the content, and the like, which are managed by the service server 20.

The motion picture selection section 107, as will hereinafter be described in detail, selects a predetermined number of motion pictures by using a predetermined reference. The predetermined reference is a reference based on an index value of a motion picture, viewing duration of content, a view log of a motion picture of the viewer or another viewer, and the like. The predetermined number means a number suitable to be displayed on the TV 200, and is desirably set depending on the display performance of the TV 200 (size of the display screen and the like).

The motion picture providing section 109 provides the motion picture information of the selected motion picture to the TV 200. Further, in response to the provision of the motion picture information, the motion picture providing section 109 acquires, from the motion picture sharing server 100, a motion picture designated by the viewer from among the selected motion pictures, and provides the acquired motion picture to the TV 200.

The recommended motion picture management section 111 manages a recommended motion picture which is registered independently of content. The recommended motion picture represents a motion picture capable of attracting a high degree of attention particularly from a general viewer among the motion pictures managed by the motion picture sharing server 10. The recommended motion picture is associated with a set keyword which is set in accordance with a substance of the recommended motion picture and is registered with the motion picture information by the administrator OP of the motion picture providing server 100.

The view log management section 113 manages a view log which indicates a viewing state the motion picture of the viewer. The view log includes an ID and viewing time and date of a motion picture which is viewed in association with content or another motion picture, an ID of the content, and the like. The view log may also include the motion picture information. The view log is generated by using the viewing state of the motion picture of the viewer, and is managed by being associated with an ID of the viewer.

### 3. CONFIGURATION OF TELEVISION RECEIVER

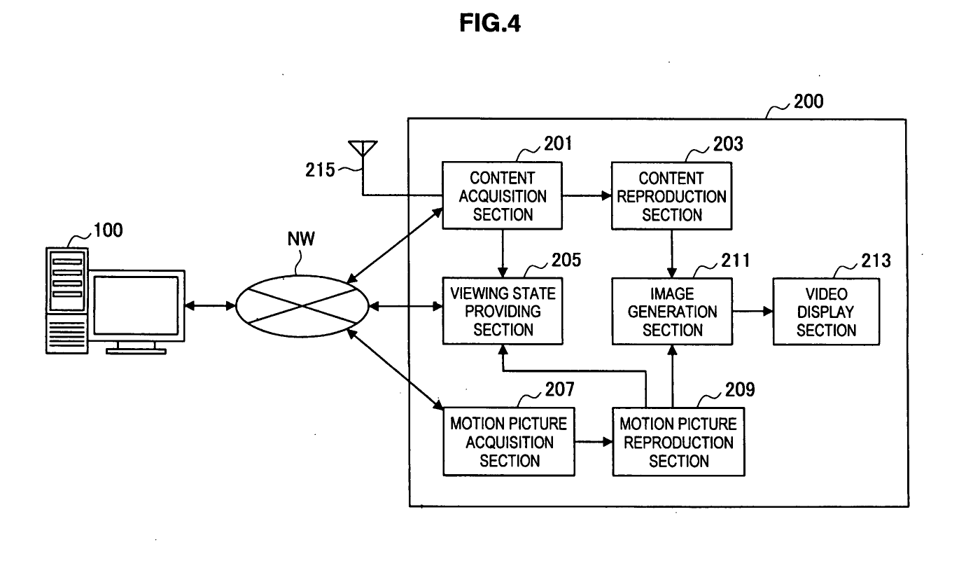

FIG. 4 is a block diagram showing a main functional configuration of the television receiver 200. As shown in FIG. 4, the TV 200 includes a content acquisition section 201, a content reproduction section 203, a viewing state providing section 205, a motion picture acquisition section 207, a motion picture reproduction section 209, an image generation section 211, and a video display section 213.

The content acquisition section 201 acquires content via an antenna 215, a network NW, or the like in response to channel operation or the like of the viewer. The content reproduction section 203 performs reproduction processing such as signal separation and decoding in order to reproduce the acquired content, and supplies the processed data to the image generation section 211.

The viewing state providing section 205 provides the viewing state of content or a motion picture to the motion picture providing server 100. The motion picture acquisition section 207 acquires a motion picture, motion picture information, and the like that are related to the content or the motion picture which is being viewed from the motion picture providing server 100. The motion picture reproduction section 209 performs reproduction processing such as signal separation and decoding in order to reproduce the acquired motion picture and the like, and supplies the processed data to the image generation section 211.

The image generation section 211 generates a display image to be displayed on the video display section 213 from a video signal of the content, the motion picture, and the like which are supplied from the content reproduction section 203 and the motion picture reproduction section 209. The video display section 213 displays generated video of the content, the motion picture, and the like.

### 4. MOTION PICTURE PROVIDING METHOD

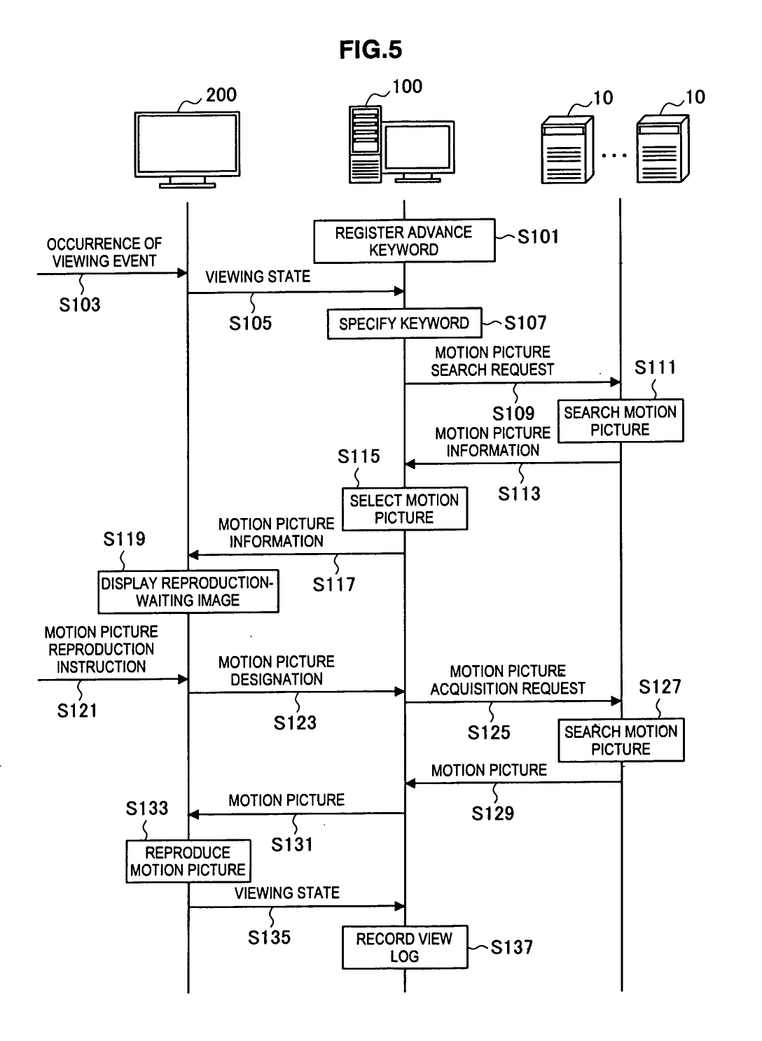

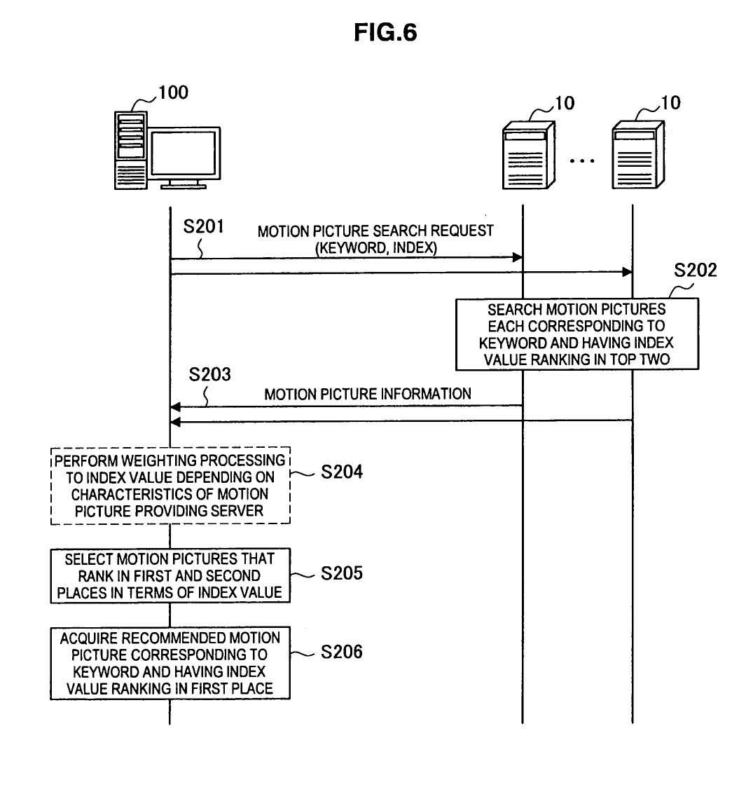

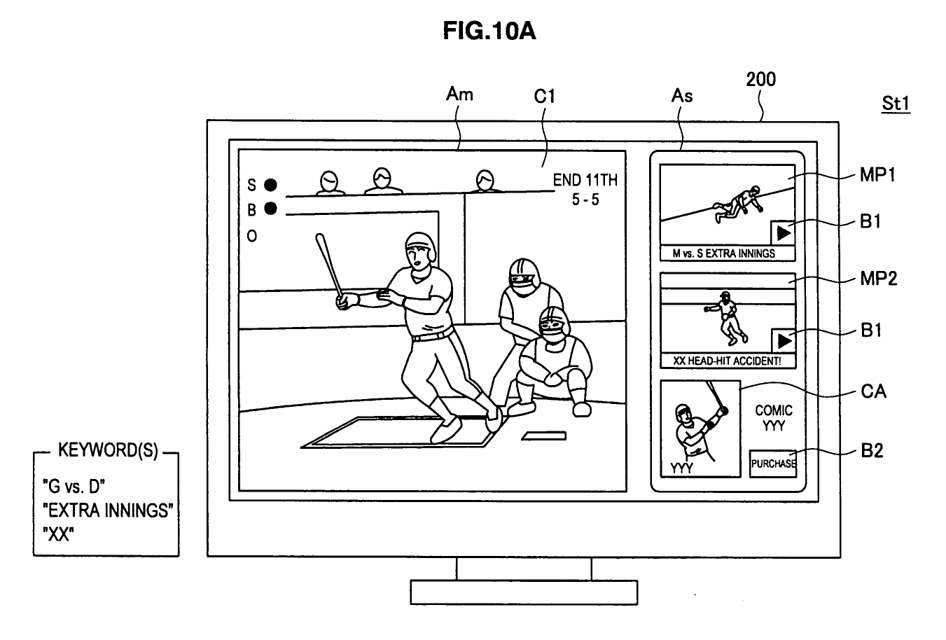

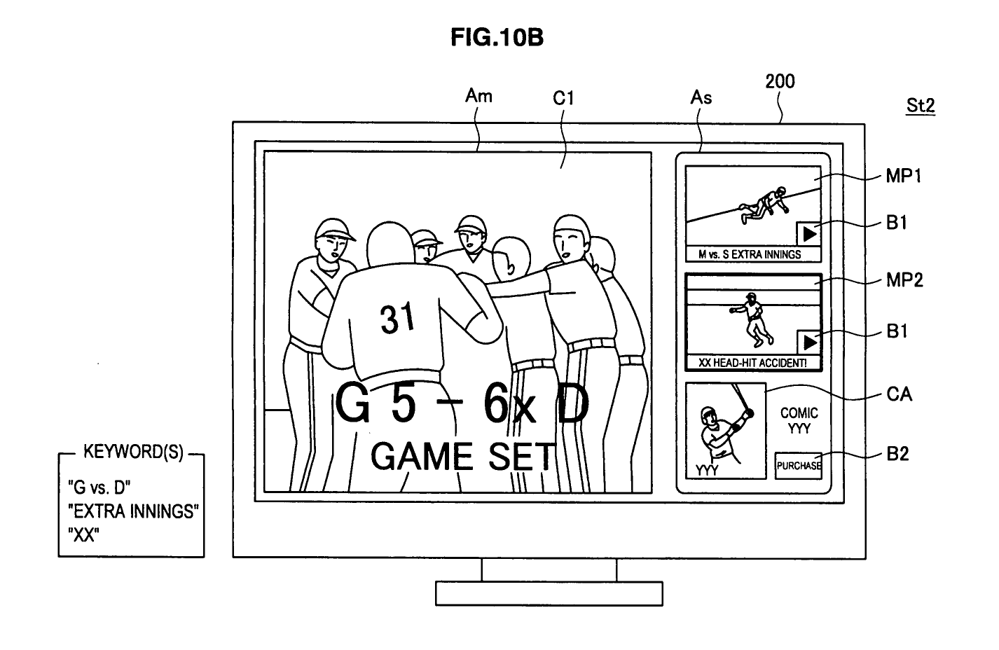

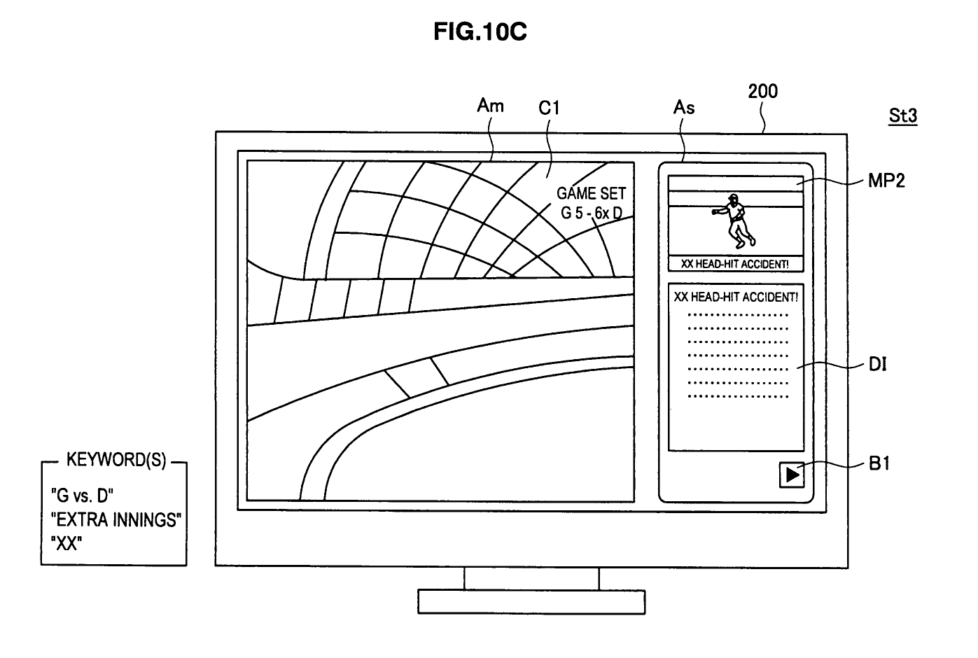

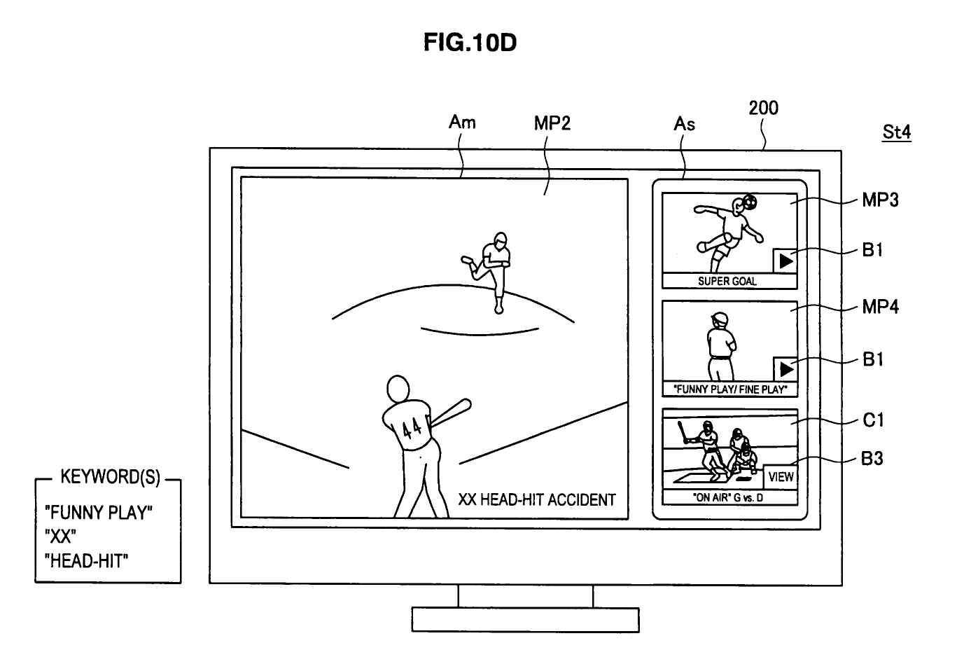

Hereinafter, with reference to FIGS. 5 to 7, motion picture providing methods according to an embodiment of the present invention will be described. FIG. 5 is a sequence diagram showing a basic procedure of a motion picture providing method. FIGS. 6, 7A, 7B, 8A to 8C, and 9 are each a diagram showing a method of selecting a motion picture. FIGS. 10A to 10D are each a diagram showing a method of displaying a motion picture.

As shown in FIG. 5, in the keyword management section 101, one or more advance keywords with respect to content are registered before the content is provided (Step S101). Further, in the recommended motion picture management section 111, a recommended motion picture is registered by being associated with a set keyword.

In response to the occurrence of a viewing event such as start/end of viewing the content or change of the content (S103), the viewing state providing section 205 transmits a viewing state of the content to the motion picture providing server 100 (S105). The viewing state includes information capable of specifying the viewer and the content which is being viewed.

When the viewing state of the content is received, the keyword specification section 105 specifies a keyword that is registered with respect to the content which is being viewed by using an ID or the like of the content (S107). Here, specified as the keyword is usually an advance keyword. However, in the case where a real-time keyword is set, a real-time keyword is further specified.

The motion picture selection section 107 transmits a search request for a motion picture including the keyword to one or more motion picture sharing servers 10 (S109). Respective motion picture sharing servers 10 each search the motion picture which corresponds to the keyword by using the received keyword (S111), and transmit pieces of motion picture information of the searched one or more motion pictures to the motion picture providing server 100 (S113). Further, the motion picture selection section 107 acquires motion picture information of the motion picture having the set keyword corresponding to the keyword from the recommended motion picture management section 111.

Here, the motion picture selection section 107 may acquire the following from a service server 20 via the motion picture sharing server 10: advertisement information of the content, information of the content which is being viewed, information related to the content which is being viewed, and the like, which correspond to the keyword. Note that, hereinafter, the case where the motion picture selection section 107 acquires a motion picture (including a recommended motion picture) will be described.

When the motion pictures are acquired, the motion picture selection section 107 selects a predetermined number of motion pictures based on an index value of a motion picture, viewing duration of content, a view log of a motion picture of the viewer or another viewer, and the like, and based on the acquired motion picture information (S115). When the motion picture is selected, the motion picture providing section 109 transmits motion picture information of the selected motion picture to the TV 200 (S117).

In the TV 200, when the motion picture acquisition section 207 receives the motion picture information, the image generation section 211 generates a reproduction-waiting image using a related image and the like included in the motion picture information, and the video display section 213 displays the reproduction-waiting image (S119).

When a motion picture is designated and the reproduction (viewing) thereof is instructed by the viewer (S121), the motion picture acquisition section 207 acquires the motion picture designated by the motion picture acquisition request from the motion picture providing server 100 (S123 to S131). After that, the motion picture reproduction section 209 performs reproduction processing of the motion picture, and the video display section 213 displays motion picture video (S133).

The viewing state providing section 205 transmits a viewing state of the motion picture to the motion picture providing server 100 depending on the reproduction (viewing) of the motion picture (S135). The viewing state includes information capable of specifying the viewer and the motion picture which is being viewed. Further, the view log management section 113 generates and records a view log which indicates occurrence of a viewing event of the motion picture (S137).

When the viewing state of the motion picture is received, the keyword specification section 105 specifies a keyword with respect to the motion picture which is being viewed. Here, the keyword of the motion picture is acquired from the motion picture sharing server 10 or the service server 20 via the motion picture providing server 100. Further, in the case where the keyword of the motion picture is registered in the keyword management section 101, an appropriate keyword may be acquired from the keyword management section 101.

The motion picture selection section 107 acquires motion picture information of a motion picture corresponding to the keyword from the motion picture sharing server 10 and the recommended motion picture management section 111. The motion picture selection section 107 may acquire information and the like of the content (including the content currently being provided) that corresponds to the keyword and relates to the motion picture which is being viewed from the service server 20 via the motion picture sharing server 10.

As is described above, when the motion picture information is acquired, pieces of motion picture information of the predetermined number of motion pictures are selected and transmitted to the TV 200. In the TV 200, reproduction-waiting images of the motion pictures are updated and displayed. The motion picture providing section 109 provides a motion picture designated by the viewer from among the selected motion pictures to the TV 200.

Further, in the keyword management section 101, one or more real-time keywords are registered with respect to content in accordance with the change that occurs in the content itself on a real-time basis.

When the real-time keywords with respect to the content which is being viewed are registered, the keyword specification section 105 specifies a registered keyword by using an ID or the like of content. Here, in the case where a real-time keyword is registered separately from an advance keyword, the keyword specification section 105 may specify only a real-time keyword, or may specify both keywords.

When the keyword is specified, the motion picture selection section 107 acquires pieces of motion picture information of the motion pictures (including a recommended motion picture) related to the content, which are searched by using the keyword. When pieces of motion picture information are acquired, the motion picture selection section 107 selects a predetermined number of motion pictures from the acquired motion pictures. Here, in the case where the search is performed by using a real-time keyword and an advance keyword, it is desirable to perform the selection of the motion picture by preferentially using the real-time keyword.

Then, the motion picture providing section 109 transmits the pieces of motion picture information of the selected motion pictures to the TV 200. In the TV 200, reproduction-waiting images of the motion pictures are updated and displayed. The motion picture providing section 109 provides a motion picture designated by the viewer from among the selected motion pictures to the TV 200.

Hereinafter, with reference to FIGS. 6, 7A, 7B, 8A to 8C, and 9, methods of selecting a motion picture will be described. In what follows, there is assumed a case where a motion picture providing system, which includes five motion picture sharing servers 10, provides three motion pictures (including a recommended motion picture) related to content. Note that the number of motion pictures to be provided is not limited to three, and may be appropriately set depending on the display performance of the TV 200.

### (4-1. Selection of Motion Picture Using Index Value of Motion Picture)

FIG. 6 shows a method of selecting a motion picture having an index value which satisfies a predetermined reference, by using a predetermined index value included in motion picture information.

The motion picture selection section 107 transmits a motion picture search request including a keyword to each of the five motion picture sharing servers 10 (Step S201). The motion picture search request is a request for acquiring motion picture information of a motion picture with respect to a predetermined motion picture corresponding to the keyword from each motion picture sharing server 10. Here, the predetermined motion picture represents a motion picture whose predetermined index value (number of reproduction times or the like of the motion picture) ranks in the top n (for example, the top two).

Note that the motion picture selection section 107 may use a motion picture search request which includes a category of the content, and acquire motion picture information of the motion picture which is obtained by search refinement by category. Here, the category of the content is specified from an ID or the like of the content by using the service server 20 or the like.

When receiving the motion picture search request, each motion picture sharing server 10 searches n (for example, two) motion pictures (S202), and transmits the pieces of motion picture information of the searched motion pictures to the motion picture providing server 100 (S203).

When the pieces of motion picture information are acquired, the motion picture selection section 107 selects pieces of motion picture information of a predetermined number of (for example, two) motion pictures from the pieces of motion picture information of the acquired (for example, ten) motion pictures, by using a predetermined index value (S205). Note that, in the case where the acquired pieces of motion picture information overlap with each other, the overlapping motion picture information is eliminated. In this case, a predetermined number of motion pictures are selected from ten motion pictures, as the motion pictures which rank in the first and second places in terms of the index value (number of reproduction times or the like of a motion picture).

Note that the predetermined index used for selecting the motion picture may be designated depending on the instruction of the viewer, from the number of reproduction times, degree of association, degree of popularity, degree of evaluation, and the like of the motion picture, for example.

Here, in the case of using the number of reproduction times or the degree of association of the motion picture as the predetermined index, the objectivity of the index value can be ensured to some extent regardless of the characteristics of the motion picture sharing server 10 (a service region, a motion picture to be managed, a user who uses the server, and the like). Therefore, it is possible to appropriately select a motion picture which is desired by a general viewer.

On the other hand, when using the degree of popularity, the degree of evaluation, or the like of the motion picture, there are cases where it is difficult to ensure the objectivity of the index value, because the characteristics of the motion picture sharing server 10 are easily reflected on the index value. For example, the following are reflected on the degree of popularity and the degree of evaluation: a service region, a motion picture to be managed, and a user who uses the server. Therefore, in the case of using the degree of popularity or the degree of evaluation as the index, it is necessary that the index value is evaluated by taking into consideration the characteristics of the motion picture sharing server 10, which is to be a providing source of the motion picture.

Accordingly, an index value of a motion picture whose providing source is a motion picture sharing server 10 may be subjected to weighting processing depending on the degree of correspondence between the providing territory and service territory of content which is being viewed, and the management number of motion pictures corresponding to the category of the content which is being viewed (S204).

Further, an index value of a motion picture corresponding to a motion picture sharing server 10 may be subjected to weighting processing depending on the kind/number of service territories, the kind/number of motion pictures to be managed, and the characteristics/number of users who use the server.

Further, as for a recommended motion picture, motion picture information of a motion picture which corresponds to a keyword and, for example, has the largest number of reproduction times is acquired from the recommended motion picture management section 111 (S206). Then, the recommended motion picture is selected preferentially to a motion picture managed by the motion picture providing server 100. However, instead of preferentially selecting the recommended motion picture, the selection of the motion picture may be performed without distinguishing between recommended motion pictures and other motion pictures, as described above.

Thus, by using the index value of the motion picture, a predetermined number of motion pictures (for example, total of three motion pictures including one recommended motion picture) can be selected from the motion picture sharing server 10 and the recommended motion picture management section 111.

### (4-2. Selection of Motion Picture Using Viewing Duration of Content)

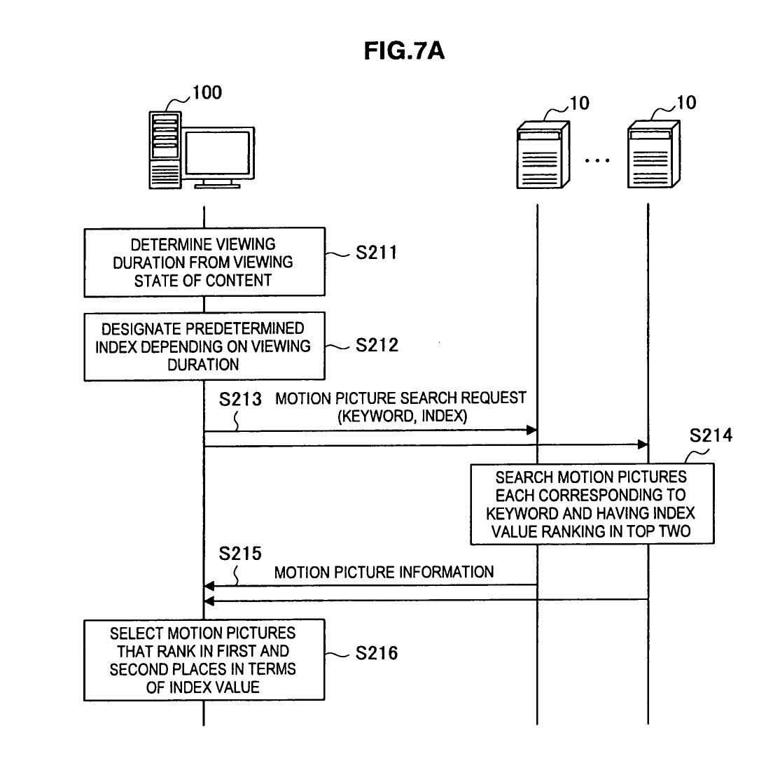

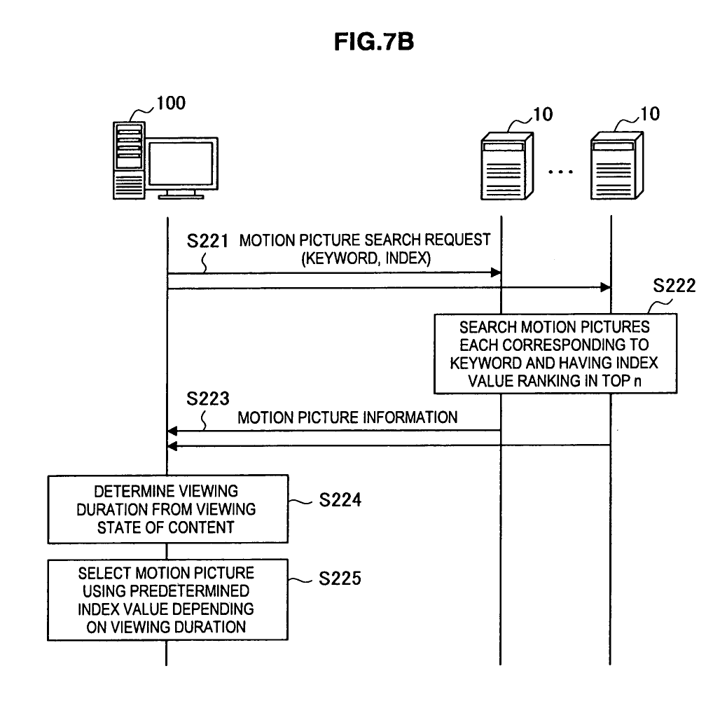

FIGS. 7A and 7B each show a method of selecting a motion picture using viewing duration of content. Note that the description of the part that overlaps with the description of FIG. 6 (in particular, weighting processing of the index value and selection of the recommended motion picture) will be omitted.

As shown in FIG. 7A, in selecting a motion picture, a motion picture having an index value which satisfies a predetermined reference may be selected by using a predetermined index depending on viewing duration of content. In this case, the viewing duration of the content can be determined from the viewing state of the content (S211), and a specific index can be designated depending on the viewing duration (S212). Note that the processing from the transmission of the motion picture search request to the selection of the motion picture (S213 to 5216) is the same as described above.

The selection of a motion picture may be performed by using the degree of popularity or the degree of evaluation of the motion picture at the start of viewing, and by using the number of number of reproduction times or the degree of association as the viewing duration increases, for example. Accordingly, there can be selected and provided a motion picture that can primarily attract the viewer's attention at the start of viewing, and a motion picture that can secondarily attract the viewer's attention as the viewing duration increases.

Further, as shown in FIG. 7B, in selecting a motion picture, a motion picture having an index value which satisfies a predetermined reference may be selected by using a predetermined index depending on viewing duration of content. In this case, the viewing duration of the content can be determined from the viewing state of the content (S224), and an index value corresponding to the motion picture to be selected can be designated (S225). Note that the processing from the transmission of the motion picture search request to the reception of the motion picture information (S221 to 5223) is the same as described above.

The selection of motion pictures may be performed in order from the motion picture having the highest index value, in a manner that, in the case where two motion pictures are to be selected, the motion pictures having the first and second highest index values, the motion pictures having the third and fourth highest index values, and so on are each selected depending on the viewing duration of the content. Accordingly, there can be selected and provided a motion picture that can primarily attract the viewer's attention at the start of viewing, which corresponds to the time of changing the content (including so-called channel zapping).

### (4-3. Selection of Motion Picture Using View Log of Motion Picture of Viewer)

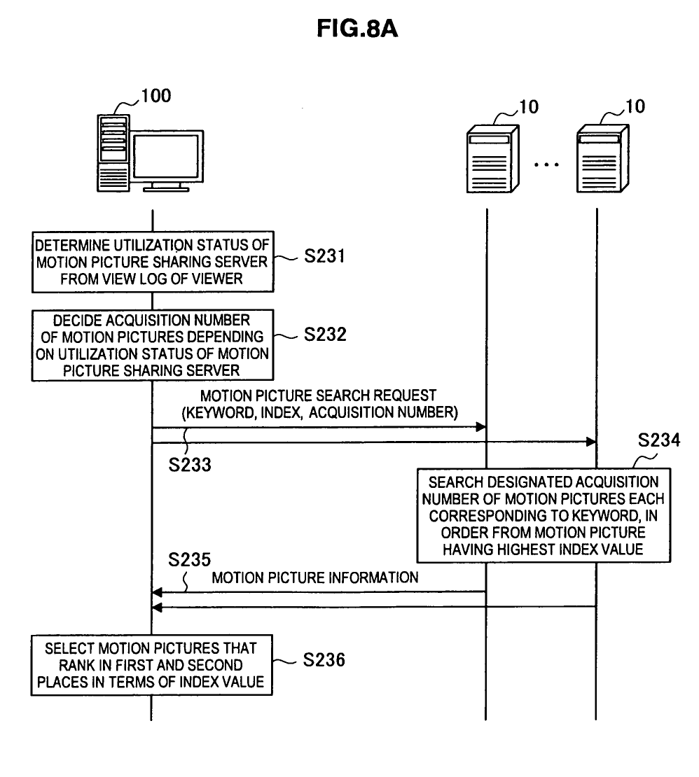

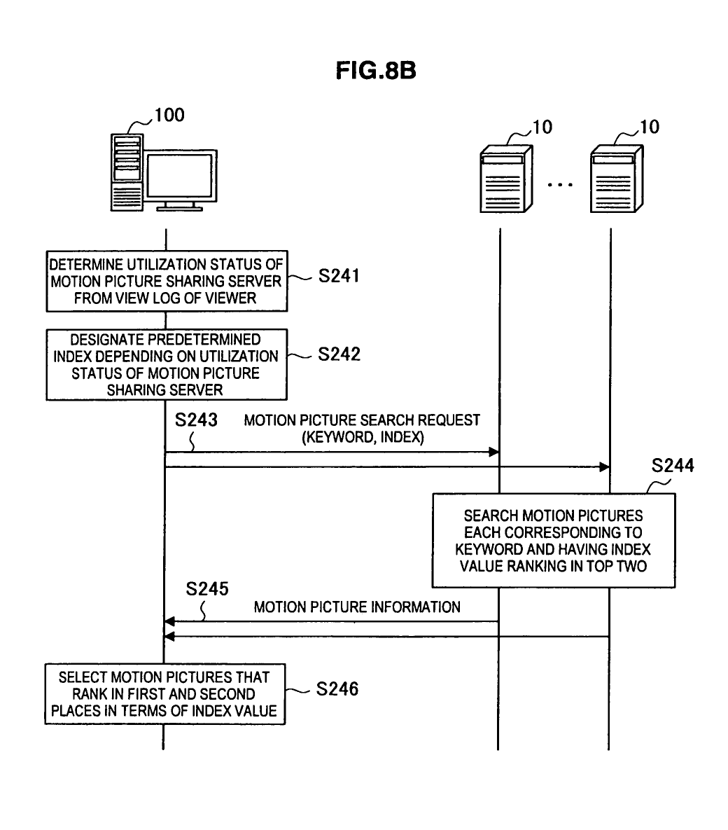

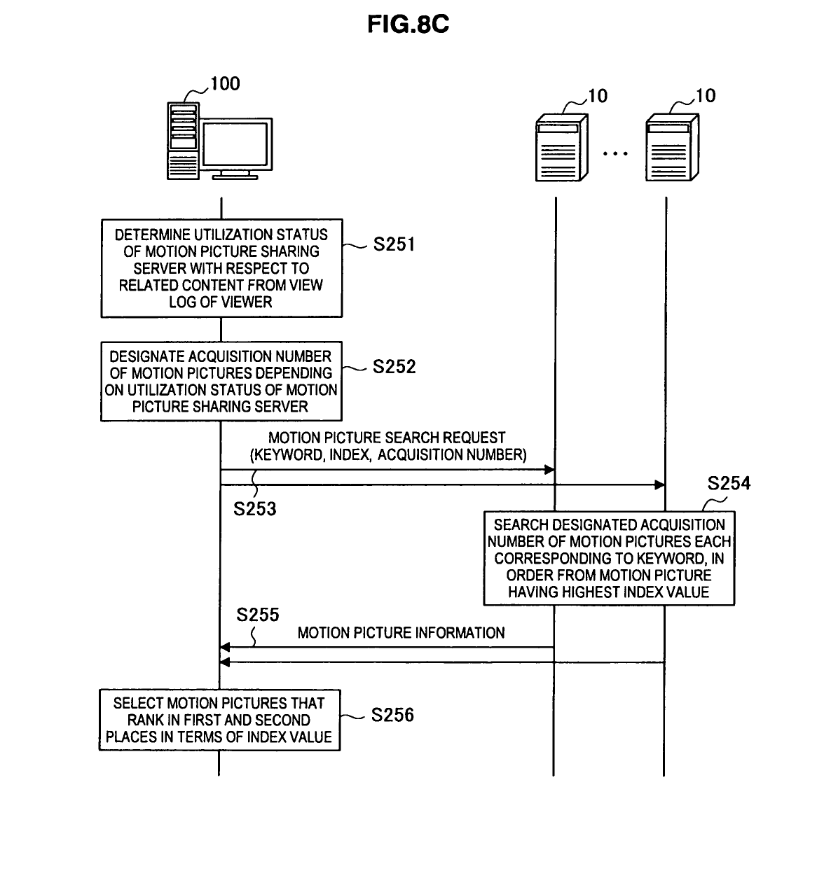

FIGS. 8A to 8C each show a method of selecting a motion picture using a view log of a viewer.

As shown in FIG. 8A, in selecting a motion picture, a motion picture which is managed by a specific motion picture sharing server 10 may be preferentially selected by using a view log of a motion picture of the viewer. In this case, the utilization status of each of the motion picture sharing servers 10 can be determined from the view log of the viewer (S231), and the number of motion pictures to be acquired from each of the motion picture sharing servers 10 can be designated (S232). Then, by using the acquisition number included in a motion picture search request, pieces of motion picture information of the motion pictures which correspond to a keyword and the number of which satisfies the acquisition number are acquired, in order from the motion picture information of the motion picture having the highest index value (S233 to S235).

The selection of a motion picture may be performed by, for example, acquiring many motion pictures from a motion picture sharing server 10 which manages many motion pictures that are viewed by the viewer, and acquiring few motion pictures from a motion picture sharing server 10 which manages few motion pictures that are viewed by the viewer. In the same manner, the selection of the motion pictures from the recommended motion picture management section 111 may be performed depending on the viewing state of the recommended motion picture of the viewer.

Further, as shown in FIG. 8B, in selecting a motion picture, a motion picture having an index value which satisfies a predetermined reference may be selected by using a predetermined index depending on a view log of a motion picture of the viewer. In this case, the viewing state of the motion picture can be determined from the view log of the viewer (S241), and a specific index can be designated by a motion picture search request (S242).

As for the selection of a motion picture, for example, when the viewer tends to view a motion picture whose number of reproduction times is large, the number of reproduction times is designated as a specific index and a motion picture whose number of reproduction times is large is acquired. Further, when the viewer tends to view a motion picture having high degree of popularity, a motion picture having high degree of popularity is acquired.

Further, as shown in FIG. 8C, in selecting a motion picture, a motion picture which is viewed by the viewer with respect to content related to the content which is being viewed may be preferentially selected by using a view log of a motion picture of the viewer.

In this case, the utilization status of each of the motion picture sharing servers 10 with respect to the related content can be determined from the view log of the viewer (S251), and the acquisition number of motion pictures can be designated (S252). Then, by using the acquisition number included in a motion picture search request, pieces of motion picture information of the motion pictures which correspond to a keyword and the number of which satisfies the acquisition number are acquired, in order from the motion picture information of the motion picture having the highest index value (S253 to S255).

Further, a motion picture corresponding to the characteristics of the motion picture which is viewed with respect to the related content may be preferentially provided. In addition, from among the motion pictures which are viewed, there may be preferentially provided a motion picture having high degree of popularity and evaluation, or a motion picture which matches the profile of the viewer.

Note that the content related to the content which is being viewed is specified from an ID or the like of the content which is being viewed by using the service server 20. Further, the motion picture which is viewed with respect to the related content and the characteristics of the motion picture are specified from an ID of the related content by using the view log of the viewer.

Thus, by using the view log of the motion picture of the viewer, a motion picture desired by the viewer can be selected and provided. Note that, in selecting a motion picture, the motion picture which has already been viewed by the viewer may not be repeatedly selected by using the view log. Here, another viewer may be selected as a viewer who has approximate profile conditions to the profile conditions of the viewer.

### (4-4. Selection of Motion Picture Using View Log of Motion Picture of Another Viewer)

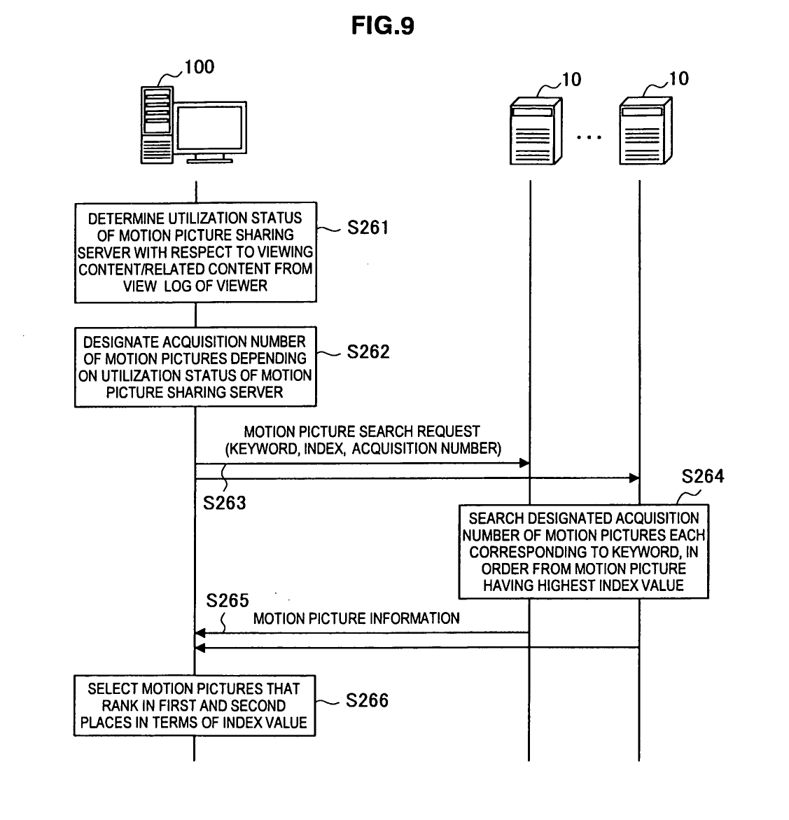

FIG. 9 shows a method of selecting a motion picture using a view log of another viewer.

As shown in FIG. 9, in selecting a motion picture, a motion picture which is viewed by another viewer with respect to content which is being viewed or content related to the content which is being viewed may be preferentially selected by using a view log of a motion picture of the other viewer.

In this case, the utilization status of each of the motion picture sharing servers 10 with respect to the content which is being viewed and/or the related content can be determined from the view log of the other viewer (S261), and the acquisition number of motion pictures can be designated (S262). Then, by using the acquisition number included in a motion picture search request, pieces of motion picture information of the motion pictures which correspond to a keyword and the number of which satisfies the acquisition number are acquired, in order from the motion picture information of the motion picture having the highest index value (S263 to S265).

Further, a motion picture corresponding to the characteristics of the motion picture which is viewed with respect to the content which is being viewed and/or the related content may be preferentially provided. In addition, from among the motion pictures which are viewed, there may be preferentially provided a motion picture having high degree of popularity and evaluation, or a motion picture which matches the profile of the viewer.

Note that the motion picture which is viewed with respect to the content which is being viewed and/or the related content and the characteristics of the motion picture are specified from an ID of the content and/or the related content by using the view log of the other viewer.

### (4-5. Method of Displaying Motion Picture)

FIGS. 10A to 10D each show an example of a method of displaying a motion picture.

In each of FIGS. 10A to 10D, a main area Am is set on the left side of a display screen and a sub-area As is set on the right side of the display screen. In the main area Am, content or a motion picture which is being viewed is displayed, and in the sub-area As, a list of motion picture information acquired from the motion picture sharing server 10 and the like is displayed.

In a state St1 shown in FIG. 10A, there is displayed in the main area Am content C1 which is being viewed, and there are displayed in the sub-area As reproduction-waiting images of motion pictures MP1 and MP2 and advertisement information CA based on the acquired motion picture information. The viewer operates reproduction buttons B1 of the reproduction-waiting images of the motion pictures MP1 and MP2 to thereby instruct the reproduction (viewing) of the motion pictures, and operates a purchase button B2 of the advertisement information CA to thereby instruct detail viewing, purchasing procedure, and the like.

Here, the content C1 represents a live broadcast of a game between baseball teams G and D. There are registered, with respect to the content C1, the following keywords: “G vs. D”, “XX”, and “extra innings”. The keyword “G vs. D” represents a combination of teams of the live broadcast, and the keyword “XX” represents the name of the player who has recently been popular in the team D, and each of the keywords are registered since an advance keyword. The keyword “extra innings” is registered as a real-time keyword, as the batting of the team D in the bottom of eleventh inning is being live broadcasted.

The motion picture MP1 “M vs. S extra innings” is selected as a motion picture corresponding to the keyword “extra innings”. The motion picture MP2 “XX head-hit accident” is selected as a motion picture corresponding to the keyword “XX”. Further, the advertisement information CA “comic YYY” is a comic about the team D, and is selected as advertisement information corresponding to the keyword “G vs. D”. Note that the selection of the motion pictures, the advertisement information, and the like may be performed by using a single keyword or by using multiple keywords.

In a state St2 shown in FIG. 10B, the motion picture MP2 is in a selected state in response to the operation of the viewer. In a state St3 shown in FIG. 10C, the motion picture MP2 is in a state where the selection thereof is decided in response to the operation of the viewer. In the state St3, a detail DI of the motion picture MP2 is displayed together with the reproduction-waiting image of the motion picture MP2 in the sub-area As.

In a state St4 shown in FIG. 10D, the reproduction (viewing) of the motion picture MP2 is started in response to the operation of the reproduction buttons B1 in the state St2 or St3. In the state St4, the reproduced video of the motion picture MP2 is displayed in the main area Am, and motion pictures MP3 and MP4 and content (content currently being provided) C1, which are related to the motion picture MP2, are displayed in the sub-area As. Note that the content related to the motion picture may be content other than the content currently being provided. The viewer can instruct to view the content currently being provided by operating a viewing button B3 of the content C1.

Here, with respect to the motion picture MP2 “XX head-hit accident”, there are registered keywords “funny play”, “XX”, and “head-hit”. The motion picture MP3 “super goal” is selected as a motion picture corresponding to the keyword “head-hitting”, and the motion picture MP4 “funny play/fine play” is selected as a motion picture corresponding to the keyword “funny play”. Further, the content C1 is selected as content currently being provided about the team D to which the player “XX” belongs.

### 5. HARDWARE CONFIGURATION OF MOTION PICTURE PROVIDING SERVER 100

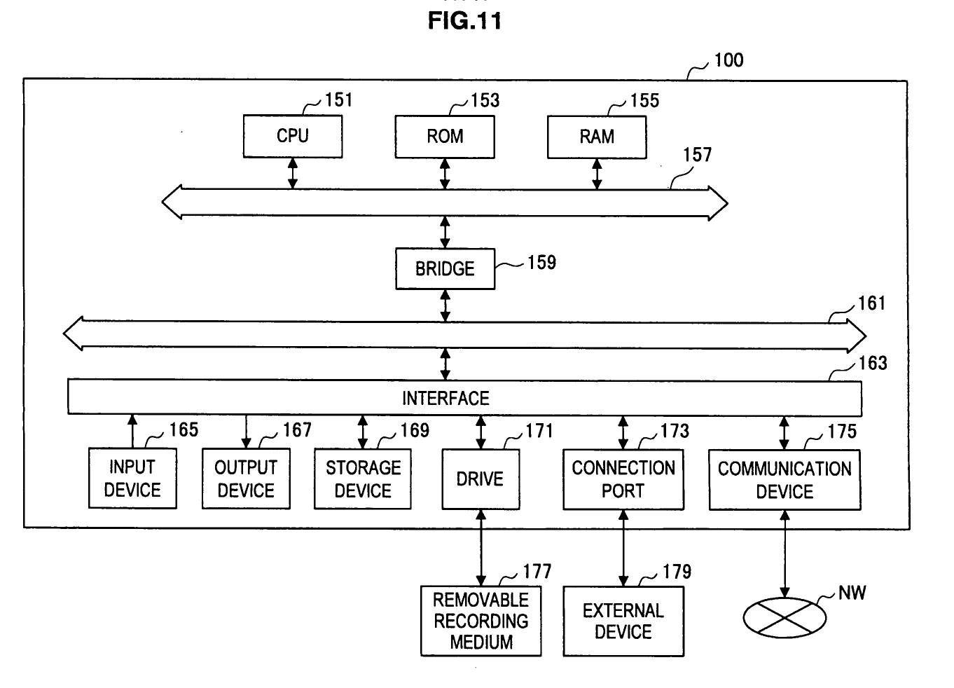

FIG. 11 is a block diagram showing a hardware configuration of a motion picture providing server. The motion picture providing server 100 mainly includes a CPU 151, a ROM 153, a RAM 155, a host bus 157, a bridge 159, an external bus 161, an interface 163, an input device 165, an output device 167, a storage device 169, a drive 171, a connection port 173, and a communication device 175.

The CPU 151 functions as an arithmetic processing unit and a control unit, and controls at least a part of the operation of the motion picture providing server 100 according to various programs recorded in the ROM 153, the RAM 155, the storage device 169, or a removable recording medium 177.

The ROM 153 stores a program, a parameter, and the like used by the CPU 151. The RAM 155 temporarily stores a program that the CPU 151 executes and a parameter or the like used at the time of executing the program. The program cooperates with other components, and functions as the keyword management section 101, the viewing state acquisition section 103, the keyword specification section 105, the motion picture selection section 107, the motion picture providing section 109, the recommended motion picture management section 111, the view log management section 113, and the like.

The CPU 151, the ROM 153, and the RAM 155 are connected to one another via the host bus 157. The host bus 157 is connected to the external bus 161 via the bridge 159.

The input device 165 is operation means which can be operated by a user of the motion picture providing server 100, such as a mouse, a keyboard, a touch panel, a button, or a switch. For example, the input device 165 generates an input signal based on operation information input by the user by using the operation means, and includes an input control circuit or the like for outputting the input signal to the CPU 151. The user inputs various kinds of data via operation of the input device 165, to thereby instruct processing operation to the motion picture providing server 100.

The output device 167 is display means such as a liquid crystal display. The output device 167 outputs processing results of the motion picture providing server 100.

The storage device 169 is a device for storing data, and includes, for example, a magnetic storage device such as an HDD. The storage device 169 stores a program executed by the CPU 151, various kinds of data, externally acquired various kinds of data, and the like. The storage device 169 stores a keyword, a recommended motion picture, a view log, and the like.

The drive 171 is a reader/writer for recording medium, and is built in or externally attached to the motion picture providing server 100. The drive 171 reads out recorded data and outputs the recorded data to the RAM 155, and writes data to be recorded on the removable recording medium 177 such as a magnetic disk which is mounted to the drive 171.

The connection port 173 is a port for directly connecting an external device 179 such as a USB port to the motion picture providing server 100. The motion picture providing server 100 acquires data via the connection port 173 and provides the data to the external device 179 which is connected to the connection port 173.

The communication device 175 is a communication interface, which includes a communication device and the like to be connected to a network NW. The communication device 175 is, for example, a communication card or the like for a wired or wireless LAN. The communication device 175 transmits/receives various kinds of data to/from the TV 200, the motion picture sharing server 10, the service server 20, and the like.

### 6. SUMMARY

As described above, according to the motion picture providing server 100 of the present embodiment, a motion picture desired by a viewer of content can be appropriately searched and provided by registering a keyword in a manner that the searching of the motion picture related to the content is an original purpose.

It should be understood by those skilled in the art that various modifications, combinations, sub-combinations and alterations may occur depending on design requirements and other factors insofar as they are within the scope of the appended claims or the equivalents thereof.

The present application contains subject matter related to that disclosed in Japanese Priority Patent Application JP 2009-238458 filed in the Japan Patent Office on Oct. 15, 2009, the entire content of which is hereby incorporated by reference.

What is claimed is:

1. A motion picture providing apparatus comprising:
a keyword management section which manages, in order to search a motion picture related to content, a keyword registered with respect to the content;
a viewing state acquisition section which acquires a viewing state of content from an outside display device;
a keyword specification section which specifies a keyword registered with respect to the content which is being viewed by using the acquired viewing state;
a motion picture selection section which selects one or more motion pictures that satisfy a predetermined reference from among one or more motion pictures searched by one or more outside motion picture sharing devices by using the specified keyword; and
a motion picture providing section which acquires, from the motion picture sharing devices, a motion picture designated by a viewer from among the selected motion pictures, and provides the acquired motion picture to the display device.

2. The motion picture providing apparatus according to claim 1,
wherein the keyword management section manages a keyword which is registered before provision of content and a keyword which is registered in association with provision of content on a real-time basis.

3. The motion picture providing apparatus according to claim 1,
wherein the motion picture selection section uses a predetermined index included in motion picture information of a motion picture which is managed by each of the motion picture sharing devices, and selects a motion picture having a value of the index which satisfies a predetermined reference.

4. The motion picture providing apparatus according to claim 3,
wherein the predetermined index is selected from at least one of a number of reproduction times, a degree of association, a degree of popularity, and a degree of evaluation of the motion picture.

5. The motion picture providing apparatus according to claim 3,
wherein the motion picture selection section evaluates a value of the predetermined index based on characteristics of two or more motion picture sharing devices, and selects a motion picture having the evaluated index value which satisfies a predetermined reference.

6. The motion picture providing apparatus according to claim 1,
wherein the motion picture selection section uses a different predetermined index depending on viewing duration of content, and selects a motion picture having a value of the index which satisfies a predetermined reference.

7. The motion picture providing apparatus according to claim 1,
wherein the motion picture selection section uses a predetermined index value depending on viewing duration of content, and selects a motion picture having the index value which satisfies a predetermined reference.

8. The motion picture providing apparatus according to claim 1,
wherein the motion picture selection section uses a view log of a motion picture of the viewer, and preferentially selects a motion picture which is managed by a specific motion picture sharing device.

9. The motion picture providing apparatus according to claim 1,
wherein the motion picture selection section uses a predetermined index depending on a view log of a motion picture of the viewer, and preferentially selects a motion picture having a value of the index which satisfies a predetermined reference.

10. The motion picture providing apparatus according to claim 1,
wherein the motion picture selection section uses a view log of a motion picture of the viewer, and preferentially selects a motion picture which is viewed by the viewer with respect to content related to the content which is being viewed.

11. The motion picture providing apparatus according to claim 1,
wherein the motion picture selection section uses a view log of a motion picture of another viewer, and preferentially selects a motion picture which is viewed by the other viewer with respect to the content which is being viewed or content related to the content which is being viewed.

12. The motion picture providing apparatus according to claim 1, further comprising
a recommended motion picture management section which manages one or more recommended motion pictures capable of attracting a high degree of attention from a general viewer,
wherein the motion picture selection section selects a motion picture which the motion picture providing apparatus manages and also selects a recommended motion picture which corresponds to a keyword from among recommended motion pictures managed by the recommended motion picture management section.

13. The motion picture providing apparatus according to claim 1,
wherein the motion picture selection section selects motion pictures, the number of which depends on display performance of the display device.

14. The motion picture providing apparatus according to claim 1,
wherein the motion picture providing section further provides information related to content associated with the content which is being viewed.

15. The motion picture providing apparatus according to claim 14,
wherein the content associated with the content which is being viewed is content currently being provided.

16. A motion picture providing method, comprising the steps executed by a computer of:
managing, in order to search a motion picture related to content, a keyword registered with respect to the content;
acquiring a viewing state of content from an outside display device;
specifying a keyword registered with respect to the content which is being viewed by using the acquired viewing state;
selecting one or more motion pictures that satisfy a predetermined reference from among one or more motion pictures searched by one or more outside motion picture sharing devices by using the specified keyword; and
acquiring, from the motion picture sharing devices, a motion picture designated by a viewer from among the selected motion pictures, and providing the acquired motion picture to the display device.

17. A program for causing a computer to execute a motion picture providing method comprising the steps of
managing, in order to search a motion picture related to content, a keyword registered with respect to the content,
acquiring a viewing state of content from an outside display device,
specifying a keyword registered with respect to the content which is being viewed by using the acquired viewing state,
selecting one or more motion pictures that satisfy a predetermined reference from among one or more motion pictures searched by one or more outside motion picture sharing devices by using the specified keyword, and
acquiring, from the motion picture sharing devices, a motion picture designated by a viewer from among the selected motion pictures, and providing the acquired motion picture to the display device.
